(19) United States
(12) Patent Application Publication
(10) Pub. No.: US 2011/0274880 A1
(43) Pub. Date: Nov. 10, 2011

(54) CONTACT PROTECTION DEVICE FOR HOLDING UNPACKAGED FOODSTUFFS

(76) Inventor: Rudolf Gotschi, Brislach (CH)

(21) Appl. No.: 13/101,361

(22) Filed: May 5, 2011

(30) Foreign Application Priority Data
May 6, 2010 (EP) 10162107.6

(51) Int. Cl. B32B 3/00

(52) U.S. Cl. 428/156

(57) ABSTRACT

Contact protection device for grasping or holding of unpackaged foodstuffs having the form of a napkin 1 made of flexible material and being provided with a handle area in the form of a protruding crease 5 in the middle section. Reinforcements (6, 7) are provided in the area of the crease and along a longitudinal edge.

The invention relates to a contact protection device for grasping or holding of unpackaged foodstuffs in the form of a napkin made of flexible material, preferably for non-contact holding of a loaf of bread during the cutting of slices of bread with a bread knife.

If bread loafs are cut into slices for consumption, the cut surfaces of the individual slices and the loaf of bread naturally dry out and harden in a short amount of time. To a large extent, the catering industry has deviated from preparing larger quantities of slices of bread for the guests. Nowadays, the whole loaf of bread is presented on buffet tables and breadboards, from which each guest can slice of bread slices, as required. The guest will touch the loaf of bread with one hand and press it onto a breadboard—with the other hand the guest holds a knife and cuts off a slice of bread.

This procedure is easy, however, it does present some disadvantages. On the one hand, the direct touching of the loaf of bread is unsanitary without protecting it from the bare hands.

In some cases, textile or paper napkins are used, which serve to protect the bread. However, the reliability of such method is not granted, because the napkins first have to be positioned onto the bread with both hands, and when moving them, both hands have to be used, again. In some cases, the napkins are touched uncontrollably, on all sides and placed onto the bread, again. This solution, as well, is unsatisfactory due to sanitary reasons.

A similar problem exists in the case of selling unpackaged foodstuffs, such as e.g. bread, pastries, fruit, etc. In such cases, the sales personnel or the client, in case of self-service stores, have to use a contact protection device to avoid touching the sales product with their bare hands. Such devices can be napkins made of paper or plastic foil. Alternatively, sometimes gloves made of PE foil are provided, as well. Both, however, are inconvenient and are frequently not used as a consequence thereof.

The object of the invention is to find means with the help of which the stated disadvantages can be avoided.

This object is solved according to the invention in that a handle area is provided in the middle section of the napkin in the form of a protruding crease.

Preferred embodiments of the invention are described with reference to the accompanying drawings, below. These show in

FIG. 1 a schematic perspective illustration of a contact protection device napkin;

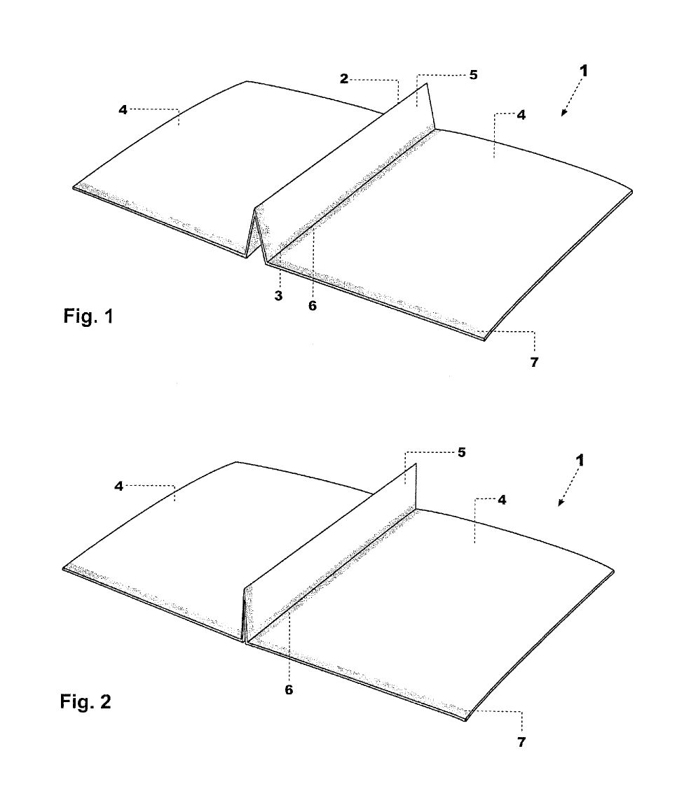

FIG. 2 a schematic illustration of another form of contact protection device napkin;

FIG. 3 a further embodiment of a contact protection device napkin;

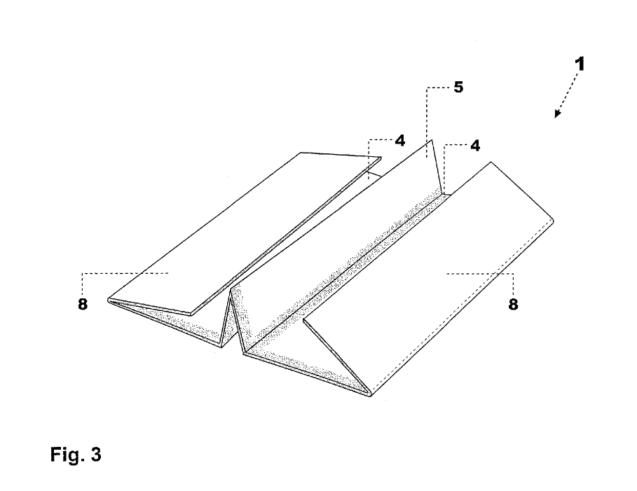

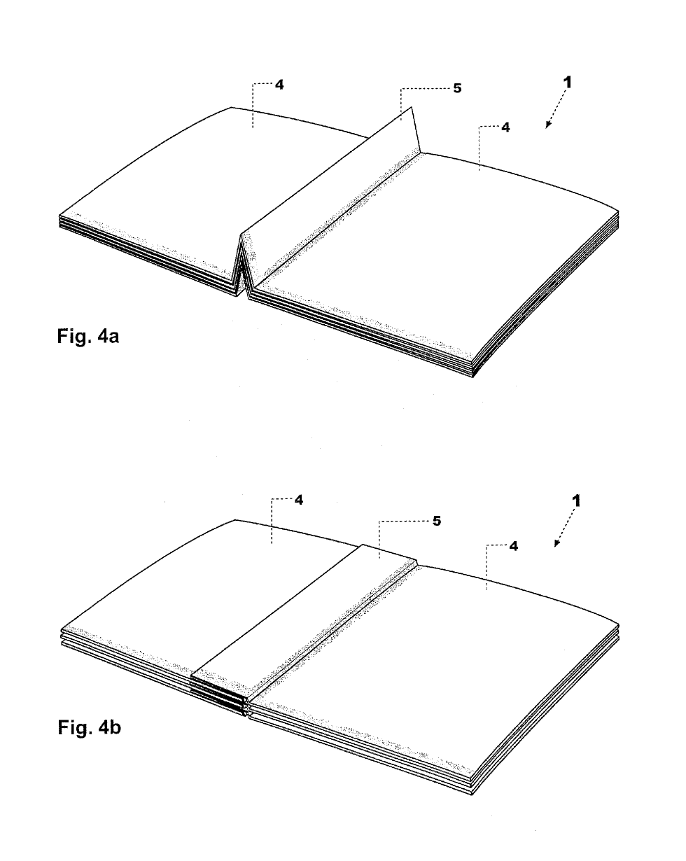

FIG. 4a,b schematic cross sectional views of batches of contact protection device napkins.

The following description of preferred embodiments contains measurement information, which, however, only illustrates examples. The measurements can certainly be chosen as desired, within the scope of useful dimensions.

The contact protection device napkin shown in FIG. 1 comprises a paper napkin 1, which is about 38 cm long and 15 cm wide, which is grooved threefold along its middle in longitudinal direction in such way that by means of an outer crease 2 and two inner crease 3 on both sides thereof a protruding crest 5 is formed by surfaces 4 of the napkin, which are separated by the folding, which crest serves a as handle area or handle. By means of this handle the napkin can be positioned with one hand as a cover onto e.g. a loaf of bread.

Alternatively, the contact protection device napkin can also comprise only one inner and one outer crease. Admittedly, the crease in such case does not protrude forming a crest prior to grasping, the grasping, however, is still possible without any problems.

To support the protruding of the handle from the surfaces 4, reinforcements 6 are provided along the inner creases 3. The reinforcements are about 20 mm wide and preferably comprise food starches incorporated into the cellulose or applied sturdy paper stripes. Alternatively, the reinforcement can also be achieved by lamination.

The handle is as long as the napkin is wide, i.e. 15 cm. The height of the handle is about 5 cm, so that the two sideways surfaces 4 still have a surface area of about 14 cm×15 cm.

In a second exemplary embodiment shown in FIG. 2, the surfaces are connected between the outer crease and the two inner creases at least partially agglutinated or by means of perforation.

In addition to the reinforcement along the inner creases, a front edge reinforcement 7, which is about 10-15 mm wide, is applied along a longitudinal border of the napkin, as well.

If the contact protection device napkin is set onto a pad, the handle is turned upwards almost perpendicularly. If the contact protection device napkin is now lifted by the handle from the pad, the two surfaces slightly incline downwards: about 5 cm at the front edge reinforcement, and a little more in the back. As a result, surfaces 4 assume a wing-like form.

Instead of the partial, i.e. stripe-formed reinforcement along the inner creases and the frontal edge, even the entire napkin can be reinforced evenly or more pronounced at certain locations and less pronounced at other locations with food starches.

To hold a loaf of bread when cutting off slices, the contact protection device napkin is grabbed by the handle and set onto the bread. When clasping the bread, the handle is pressed together or turned. Thus, the bread is being protected by the contact protection device napkin and can be either held onto, tilted sideways or lifted when a slice of bread is cut off. In doing so, it is important that the hand can feel the unevenness of the bread and thus optimally utilize the adhesion. The pressed together or turned handle does not form an obstacle in connection with the goal of feeling the unevenness of the bread. The soft, flexible material of the napkin allows feeling the loaf of bread in a way as if there was no material present between the bread and the hand. The bread can be grabbed as if this were done with the bare hands, i.e. the user has “a handle” on the bread.

Handle 5 enables handling the cellulose cover with one hand as well as purposefully. It can be grabbed in such a comfortable way that the user does not even think of touching the contact protection device napkin on the bottom side.

The handle rises upwards by means of the reinforcements after being pressed down, in a way that it can be easily grabbed between thumb and index finger, and the contact protection device napkin can be moved or taken away from the loaf of bread and set down onto a surface area.

Because the handle is wider than a hand, which grabs the handle in the center, the reinforcement remains turned upwards at the front side of the handle when pressing onto the handle. This results in a signal to the effect that the bread holder ends at this point. This means that a certain security, a security distance, exists prior to the knife about to begin cutting. In addition, the reinforcement of the front section can be advantageously offset in contrasting colors so that it forms a secure border in the cutting area.

The contact protection device napkin has a plurality of advantages. It complies with the requirements of sanitation to the highest degree and is convenient to use. It is a disposable article and requires no washing-up, but is nevertheless environmentally friendly based on the used material. The material is familiar to the user due to the utilization of paper napkins.

Instead of paper or cellulose as material for the napkin, a different material can be used as well, for example transparent plastic foils. This can be useful for application in the sale of unpackaged foodstuffs because the product is visible during handling. The client can grasp displayed fruit to inspect it or to place it into a shopping bag. The contact protection device napkin can be set down onto a pad after use.

For certain applications, e.g. to grasp fatty objects such as fried sausages, etc. it might be convenient to fabricate the entire napkin of two layers, for example, e.g. with tissue paper laminated with PE foil. The foil can be very thin, but does effectuate the desired elastic or resettable effect. The foil does not allow fat to pass through so that the tissue paper remains clean for wiping the mouth.

For the purpose of transporting, storing and provision a respective amount of contact protection device napkins is stacked up in a cardboard box, as shown in FIG. 4a. The cardboard box is opened in the middle of the upper side in a way known to the art, so that one contact protection device napkin after the other can be removed. If the handle is agglutinated, it is leveled laterally, as shown in FIG. 4b. To be able to grab the handle, the thumb or index finger is moved under the leveled handle, which has the tendency to lift up due to the consistency of the reinforcement.

Pursuant to another exemplary embodiment shown in FIG. 3, the two surface areas 4 are folded up by about half by means of another folding. This entails further advantages. On the one hand, this achieves narrow packaging. On the other hand, the area folded up in the form of a flap 8 can form an additional contact protection. When grabbing the handle, the fingers naturally slide under the folded up flaps 8, which prevents contact with adjacent pastry, fruit, etc.

The flaps have the tendency to return to their initial positions and thus form something like a pocket.

The size of the contact protection device napkin can vary, of course. A laminated embodiment for the grasping of fried sausages can be limited to a size of 15×15 cm for example, which causes savings in material.

1. A contact protection device for grasping or holding of unpackaged foodstuffs in the form of a napkin (1) made of flexible material, characterized in that a handle area in the form of a protruding crease (5) is formed in the middle section of the napkin.

2. The contact protection device according to claim 1, characterized in that a reinforcement (6) is provided in the area of the crease.

3. The contact protection device according to claim 1, characterized in that a reinforcement (7) is provided along a longitudinal edge.

4. The contact protection device according to claim 1, characterized in that the surface areas on both sides of the crease are folded in.

5. The contact protection device according to claim 2, characterized in that the reinforcement comprises food starch.

6. The contact protection device according to claim 3, characterized in that the reinforcement comprises food starch.
